(19) United States
(12) Patent Application Publication
(10) Pub. No.: US 2002/0135156 A1
(43) Pub. Date: Sep. 26, 2002

(54) Multi-linking, rear glide suspension system for two-wheeled motor vehicles

(76) Inventor: Greg M. Parigian, Chatsworth, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/152,527

(22) Filed: May 21, 2002

Related U.S. Application Data
(63) Continuation-in-part of application No. 10/050,315, filed on Jan. 15, 2002.
Application No. 10/050,315 is a continuation-in-part of application No. 09/740,517, filed on Dec. 19, 2000, now abandoned.

(51) Int. Cl. B62K 1/00

(52) U.S. Cl. 280/286

(57) ABSTRACT

A rear suspension system for two-wheeled motor vehicles having a generally triangular configuration includes first and second spaced apart support axle plates having aligned apertures that receive an axle of a rear wheel of the vehicle. An upper arm assembly is pivotally connected between a frame of the vehicle and the first and second support plates. A lower arm assembly extends from the first and second support axle plates. The lower arm assembly is pivotally connected to a pivot arm assembly. A shock unit is pivotally connected to the lower arm assembly at one end, and to the vehicle frame at the opposite end. The system provides improved wheel contact with the ground and rear wheel control and stability.

### RELATED APPLICATIONS

This application is a continuation-in-part of U.S. application Ser. No. 10/050,315, filed Jan. 15, 2002, which is a continuation-in-part of U.S. application Ser. No. 09/740,517, filed Dec. 19, 2000.

### BACKGROUND OF THE INVENTION

The present invention relates generally to two-wheeled vehicles. More particularly, the present invention relates to a rear suspension system for two-wheeled motor vehicles, such as motorcycles, employing pivoting arm assemblies and control arm possessing shock absorption characteristics to provide lateral stability.

The existing designs of most prior art rear suspension assemblies for two-wheeled motor vehicles include a rear pivot from a single point either from a dual or mono shock system that either extends or comprises the shock unit. In this respect, when the shock system is affected by power or braking to the rear wheel, system efficiency and stability are compromised. Other systems use a quad-type configuration that only connects to a small section of the frame, providing less structural integrity.

Although recent motorcycle frames include a swing arm configuration, these configurations posses certain deficiencies that detract from their overall utility. The swing arm movement is typically in a pivoting motion upwardly and directed towards the front part of the motorcycle. This causes lateral instability for the rear wheel of the motorcycle. Many existing suspension systems provide inadequate control of the wheel to pavement contact. This can create safety concerns regarding the control of the increased stopping during braking. Aside from the rear wheel wobbling, as described above, many current designs transfer force back to the front of the vehicle under acceleration.

Accordingly, there is a need for a rear suspension system for a two-wheeled motor vehicle which improves rear wheel geometry. Such a system should also increase lateral stability of the rear wheel of the vehicle and improve wheel contact with the pavement. Such a system should further contain the power under acceleration and not transfer force back to the front of the vehicle. The present invention fulfills these needs and provides other related advantages.

### SUMMARY OF THE INVENTION

The present invention relates to a rear suspension system for two-wheeled motor vehicles. The system includes first and second spaced apart and parallel support axle plates. The first and second support axle plates include aligned apertures configured to receive an axle of a rear wheel of the two-wheeled vehicle, such as a motorcycle.

An upper arm assembly is pivotally connected at a first end thereof to a vehicle frame, and at a second end thereof to the first and second support axle plates. The upper arm assembly is comprised of a base pivotally connected to the vehicle frame. A first elongated arm extends from the base to a pivotal connection point at the first support axle plate. A second elongated arm extends from the base generally parallel to the first arm to a pivotal connection point at the second support axle plate.

A lower arm assembly is connected at a first end thereof to the first and second support axle plates, and pivotally connected at a second end thereof to a pivot arm assembly. The lower arm assembly includes a base pivotally attached to the pivot arm assembly and having a first elongated arm extending therefrom to a connection point at the first support axle plate. A second elongated arm extends from the base generally parallel to the first arm to a connection point at the second support axle plate.

The pivot arm assembly is pivotally connected at a first end to the vehicle frame, and at a second end to the lower arm assembly. The pivot arm assembly comprises a pair of angular brackets spaced apart and generally parallel to one another and having a shaft extending between first ends thereof for pivotal connection to the vehicle frame. A shaft extends through second ends thereof for pivotal connection to the first and second arm of the lower arm assembly.

A compressible shock unit is associated at one end with the lower arm assembly or pivot arm assembly, and connected at the opposite end thereof to the vehicle frame. In a particularly preferred embodiment, the shock unit is pivotally connected to the base of the lower arm assembly at one end, and pivotally connected to the vehicle frame at the other end of the shock unit generally opposite the lower arm assembly. The above-described system has a generally triangular configuration. With the system of the present invention, lateral stability is created for the rear wheel of the two-wheeled vehicle.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a side elevational view of a motorcycle incorporating a rear suspension system embodying the present invention;

FIG. 2 is a perspective view of the rear suspension system embodying the present invention;

FIG. 3 is a side elevational view of the rear suspension system of FIG. 2 in a relaxed state; and

FIG. 4 is a side elevational view of the rear suspension system of FIG. 2 in a compressed state.

### DETAILED DESCRIPTION OF THE PREFERRED EMBODIMENT

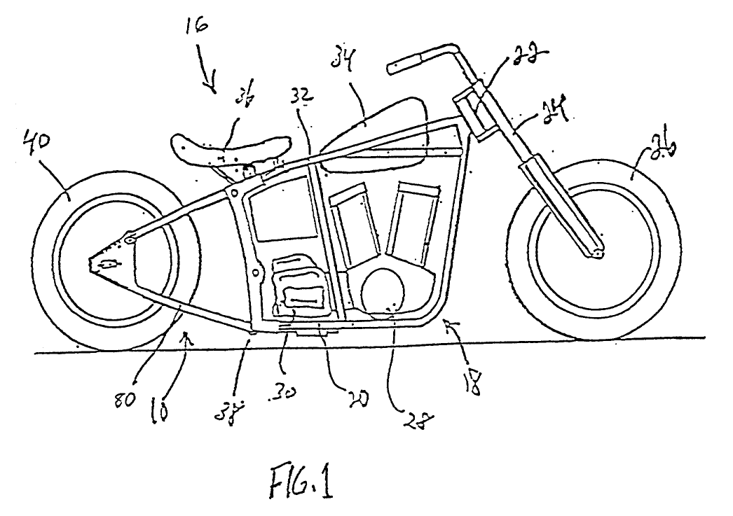

As shown in the drawings for purposes of illustration, the present invention is concerned with a rear suspension system for two-wheeled vehicles, generally referred to by the reference number 10 in FIGS. 1-4. The rear suspension system 10 is particularly designed and adapted for use in a motorcycle 16, although it could conceivably be incorporated into any two-wheeled motorized vehicle.

With reference to FIG. 1, a motorcycle 16 is illustrated incorporating the rear suspension system 10 of the present invention. The primary structural component of the motorcycle is the frame 18. The frame 18 is typically comprised of two bottom support tubes 20 which are bent at an upwardly directed angle at a front end thereof to a head tube 22. The head tube 22 is connected to a front wheel torque assembly 24 upon which the front wheel 26 is rotatably mounted. The bottom support tubes 20 also provide an anchor and base for the motor 28, transmission 30, etc. A top support tube 32 extends from the head tube 22 towards the rear of the motorcycle 16, and supports the gas tank 34, seat 36, etc. A rear pair of tubes or brackets 38 interconnect the top and bottom support tubes 32 and 20, and serve as a rear end of the overall frame 18. Conventionally, the rear suspension is connected to the rear pair of tubes 38 with cross bars or the like. In the present invention, a generally triangular triaxial suspension system 10 extends between the rear tubes 38 and the rear wheel 40 of the motorcycle 16.

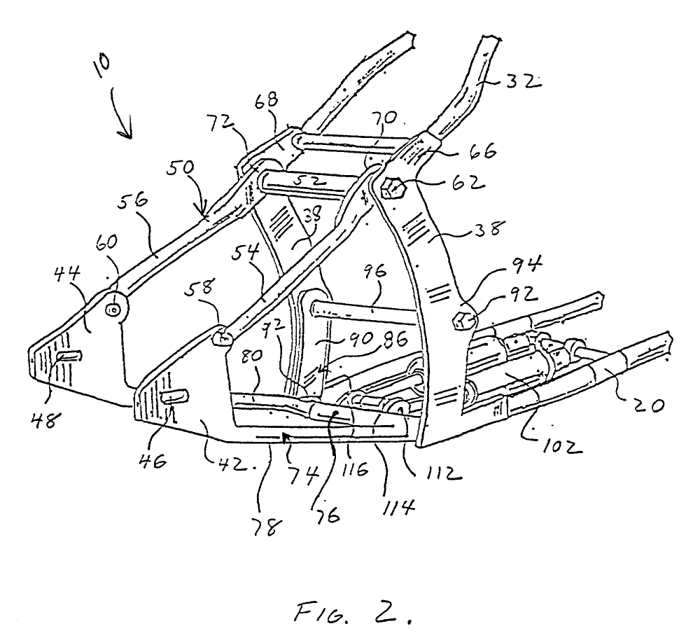

With reference to FIG. 2, the rear suspension system 10 of the present invention includes a pair of spaced apart and parallel support axle plates 42 and 44 having aligned apertures 46 and 48 which are configured to receive an axle of the rear wheel 40 of the motorcycle 16, or other two-wheeled vehicle. An upper arm assembly 50 is interconnected between the rear tubes 38 of the frame 18 and the axle plates 42 and 44. The upper arm assembly 50 is generally U-shaped, and includes a base 52 having first and second elongated arms 54 and 56 extending therefrom to pivotal connection points 58 and 60 of the axle plates 42 and 44, respectively. Typically, the arms 54 and 56 are pivotally connected to an upper portion of the base 52 such as by rocker arm fasteners, pins, bushings, etc. which allows the arms 54 and 56 to pivot and rotate. The upper arm assembly 50 is pivotally connected to the rear tubes 38 of the frame 18, typically by pins or bolts 62 and 64 extending between upper mounting ears 66 and 68 of the rear tubes 38 of the frame 18, and ends 70 and 72 extending of the upper arm assembly arms 54 and 56. Of course, other appropriate means of pivotally connecting the upper arm assembly 50 to the rear portion of the frame 38 can also be used.

A lower arm assembly 74 extends adjacent to a lower portion of the rear end 38 of frame 18, and a lower end of each axle plate 42 and 44. The lower arm assembly 74 includes a generally U-shaped member having a base 76 and elongated arms 78 and 80 extending from the base 76 to each respective axle plate 42 and 44.

The lower arm assembly 74 is pivotally connected to the frame 18 via a pivot arm assembly 86. This assembly 86 is generally H-shaped and includes two brackets 88 and 90 which are spaced apart from one another so as to be generally parallel to one another. A shaft or pin 92 extends between a first end of the brackets 88 and 90 for pivotal connection to mounting ears 94 extending from the rear frame tubes 38. Similarly, a shaft of pin 96 extends through the opposite ends of the brackets 88 and 90 for pivotal connection to the base 76 of the lower arm assembly 74. The pivot arms 88 and 90 may also have an angled configuration.

A shock unit 102, such as a shock absorber typically having a compressible spring, is pivotally interconnected between the lower tubes 20 of the frame 18 and the lower arm assembly 74 or pivot arm assembly 86. Typically, this is done by connecting an upper end of the shock unit 102 with an appropriate fastener 106, such as a rotatable pin or the like, to mounting ears 108 and 110 extending from the lower tubes 20 of the frame 18, or any other rear end portion of the frame 18. The opposite end of the shock unit 102 is pivotally attached intermediate ends of the lower arm assembly brackets 114 and 116. This is done by attaching the appropriate fastener, such as a pin 112 or the like.

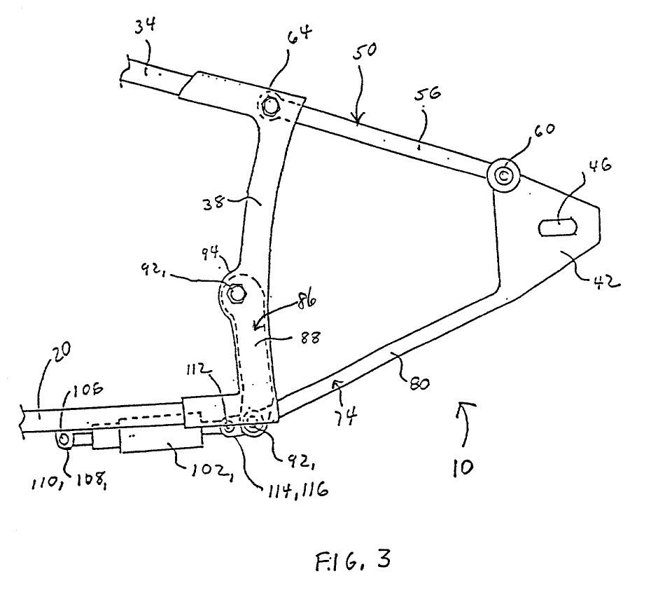

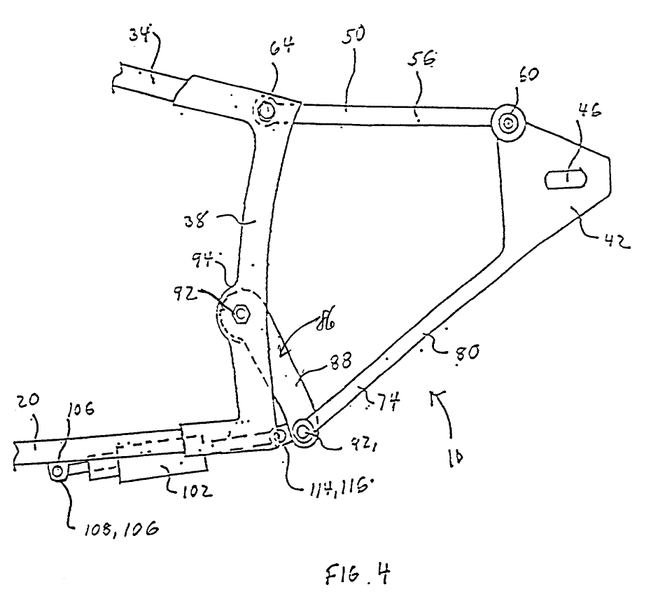

With reference to FIGS. 3 and 4, FIG. 3 illustrates the suspension system 10 in a relaxed state. FIG. 4 illustrates the suspension system 10 in a compressed state, such as when the rear wheel 40 encounters a bump. As the motorcycle 16 moves and is subjected to uneven surface bumps or ruts, the system 10 acts in the following manner. The overall movement can best be described as a knee-action movement. As the shock unit 102 is actuated and extended from pressure of the moving wheel 40, the pivot arm assembly 86 is pivoted rearwardly about the axis of fasteners 92. This results in the lower arm assembly 74 pivoting in an upward planar motion causing the axle plates 42 and 44 to move upwardly in a planar motion as well. The upper arm assembly 56 also articulates and pivots upwardly in response at both pivot points 60 and 64. This nearly vertical upwardly directed planar motion results in a minimal amount of frontal directional movement. The amount of travel of motion of the system is controlled by the shock unit 102.

The downward rebound pivotal motion of the rear suspension system 10 is essentially the reverse of that described above. As the spring shock unit 102 relaxes after rebound, the pivot arm assembly 86 pivots in a downward motion causing the lower arm assembly 74 to move in a downward motion. This in turn causes the axle support plates 42 and 44 to move downward, resulting in the upper arm assembly 50 being pulled downward also. The upwardly and downwardly directed motions are eventually ceased by virtue of the shock absorbing unit 102. As this pressure is reduced, the system 10 reverses this action and conforms to its balanced pre-shock tension position, as illustrated in FIG. 3.

Use of the present invention is advantageous over existing rear suspension systems in that improved rear wheeled contact with the ground is achieved. Also, rear wheel control and stability is also greatly increased, resulting in additional safety.

Although an embodiment has been described in detail for purposes of illustration, various modifications may be made without departing from the scope and spirit of the invention. Accordingly, the invention is not to be limited, except as by the appended claims.

What is claimed is:

1. A rear suspension system for two-wheeled motorized vehicles, comprising:
first and second spaced apart and parallel support axle plates;
an upper arm assembly pivotally connected at a first end thereof to a vehicle frame and pivotally connected at a second end thereof to the respective first and second support axle plates;
a lower arm assembly extending from the first and second support axle plates;
a pivot arm assembly pivotally connected at a first end to a rear end of a frame of the vehicle and pivotally connected at a second end thereof to the lower arm assembly; and
a compressible shock unit associated at one end thereof with the lower arm assembly or pivot arm assembly and connected at the opposite end thereof to the vehicle frame.

2. The suspension system of claim 1, wherein the system has a generally triangular configuration.

3. The suspension system of claim 1, wherein the upper arm assembly is comprised of a base pivotally connected to the vehicle frame and a first elongated arm extending from the base to a pivotal connection point at the first support axle plate, and a second elongated arm extending from the base generally parallel to the first arm to a pivotal connection point at the second support axle plate.

4. The suspension system of claim 1, wherein the lower arm assembly includes a base and a first elongated arm extending from the base to the first support axle plate, and a second elongated arm extending from the base generally parallel to the first arm to the second support axle plate.

5. The suspension system of claim 4, wherein the pivot arm assembly comprises a pair of angular brackets spaced apart and generally parallel to one another and having a shaft extending between first ends thereof for pivotal connection to the vehicle frame, and a shaft extending through second ends thereof for pivotal connection to the base of the lower arm assembly.

6. The suspension system of claim 4, wherein the shock unit is pivotally connected to the base of the lower arm assembly.

7. The suspension system of claim 6, wherein the shock unit is pivotally connected to the vehicle frame at an end of the shock unit generally opposite the lower arm assembly.

8. The suspension assembly of claim 1, wherein the first and second support axle plates include aligned apertures configured to receive an axle of a rear wheel of the two-wheeled vehicle.

9. A rear suspension system for a motorcycle, comprising:
first and second spaced apart and parallel support axle plates having aligned apertures configured to receive an axle of a rear wheel of the motorcycle;
an upper arm assembly including a base pivotally connected to the vehicle frame, a first elongated arm extending from the base to a pivotal connection point at an upper end of the first support axle plate, and a second elongated arm extending from the base generally parallel to the first arm to a pivotal connection point at an upper end of the second support axle plate;
a lower arm assembly including a first elongated arm extending from a lower end of the first support axle plate to a base, and a second elongated arm extending from a lower end of the the second support axle plate to the base;
a pivot arm assembly pivotally connected at a first end to a motorcycle frame and pivotally connected at a second end thereof to the base of the lower arm assembly; and
a compressible shock unit connected at one end thereof with the lower arm assembly and connected at the opposite end thereof to the motorcycle frame.

10. The suspension system of claim 9, wherein the system has a generally triangular configuration.

11. The suspension system of claim 9, wherein the pivot arm assembly comprises a pair of angular brackets spaced apart and generally parallel to one another and having a shaft extending between first ends thereof for pivotal connection to the motorcycle frame, and a shaft extending through second ends thereof for pivotal connection to the lower arm assembly.

12. The suspension system of claim 9, wherein the shock unit is pivotally connected to the base of the lower arm assembly at one end thereof.

13. The suspension system of claim 12, wherein the shock unit is pivotally connected to the motorcycle frame at an end of the shock unit generally opposite the lower arm assembly.
